(19) United States
(12) Patent Application Publication
(10) Pub. No.: US 2008/0283627 A1
(43) Pub. Date: Nov. 20, 2008

(54) Fuel Injector

(76) Inventors: Friedmar Dresig, Chemnitz (DE); Maik Paehrisch, Bamberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/096,501

(22) PCT Filed: Nov. 27, 2006
(86) PCT No.: PCT/EP2006/068952

§ 371 Date: Jun. 6, 2008

(30) Foreign Application Priority Data
Jan. 23, 2006 (DE) 10 2006 003 040.0

(51) Int. Cl. F02M 61/04

(52) U.S. Cl. 239/124; 123/445

(57) ABSTRACT

A fuel injector for internal combustion engines, the injector a nozzle needle axially guided for movement in a nozzle body to opens or close off at least one spray hole for a fuel injection, having a valve piston is guided so as to be axially moveable in a holding body and controls the opening and closing movement of the nozzle needle, having a valve piece in which the valve piston delimits a control space which is connected to a high-pressure side and which is connected by means of a control valve to a low-pressure side, and having a leakage oil return line which discharges leakage oil out of the region of the holding body. The leakage oil return line runs at least partially in the valve piece.

### PRIOR ART

The invention is based on a fuel injector as generically defined by the preamble to claim 1.

Diesel common rail injection systems including fuel injectors and their components are exposed to powerful pressure loads during operation. The intensity of the pressure corresponds approximately to the injection pressures to be produced in the engine. The higher these injection pressures, the better the engine behavior (performance/fuel consumption/noise/emissions). As in the past, in future, these pressures must be increased to the greatest extent possible. However, prior designs are reaching their limits in terms of geometrical layout.

In known fuel injectors, leakage is conveyed away from the holding body by means of a leakage oil return line that extends in the holding body and feeds into a separate low-pressure-side chamber of the holding body.

### ADVANTAGES OF THE INVENTION

The internal combustion engine fuel injector according to the present invention, with the defining characteristics of claim 1, serves to increase pressure, reduce costs, and improve quality. The present invention makes it possible to eliminate production processes in the holding body that reduce strength. It eliminates the burr formation at the intersection between the leakage oil pocket and the leakage oil groove dictated by the current design. This eliminates the need for the work step of burr removal and on the whole, eliminates the need for several work steps. Wall thickness problems are solved so that for example, a longer and more ruggedly constructed valve clamping screw (more load-bearing thread turns) can be used to clamp the holding body, which in turn permits increases in pressure. The present invention makes it possible to implement fuel injectors with a higher operating pressure or to at least come closer to this goal. The construction according to the present invention simplifies the design of the fuel injector and reduces the number of finishing steps. It is also possible to increase the strength of the holding body and to increase the pressure of the fuel injector.

Other advantages and advantageous embodiments of the subject of the present invention can be inferred from the description, the drawings, and the claims.

### DRAWINGS

Two exemplary embodiments of the fuel injector according to the present invention are shown in the drawings and will be explained in greater detail in the subsequent description.

FIG. 1 is an overview of the fuel injector according to the present invention;

FIG. 2 is a detail view in the region of the valve element from FIG. 1; and

FIG. 3 shows a second exemplary embodiment of the fuel injector according to the present invention in a depiction analogous to the one shown in FIG. 2.

### DESCRIPTION OF THE EXEMPLARY EMBODIMENTS

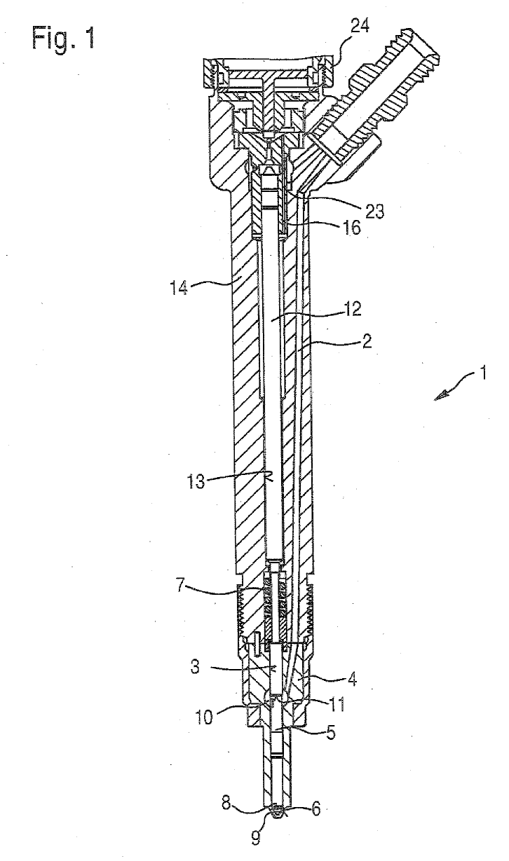

The fuel injector 1 shown in FIG. 1 is situated in a high-pressure injection line 2 of the fuel and protrudes into the combustion chamber of the internal combustion engine to be fed.

A piston-shaped valve member (nozzle needle) 5 with a conical valve sealing surface 6 is movably supported in an axial guide bore 3 of a nozzle body 4, is pressed against a conical valve seat surface 8 of the nozzle body 4 by a closing spring 7, and closes the injection ports 9 provided there. The injection line 2 in the nozzle body 4 feeds into an annular pressure chamber 10 from which an annular gap extending between the guide bore 3 and nozzle needle 5 leads to the valve seat surface 8. In the vicinity of the pressure chamber 10, the nozzle needle 5 has a control surface 11 embodied in the form of a pressure shoulder by means of which the fuel supplied via the injection line 2 acts on the nozzle needle 5 in the opening direction.

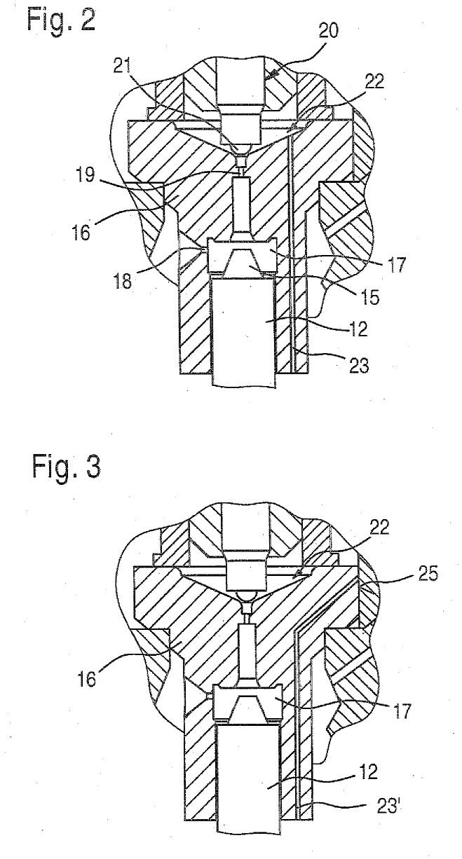

The opening and closing motion of the nozzle needle 5 is controlled by a valve piston 12 that is guided in an axially movable fashion in a guide bore 13 of a holding body 14 and with its one end, acts axially on the end surface of the nozzle needle 5 oriented away from the valve sealing surface 6. As shown in FIG. 2, at its other end, the valve piston 12 has a control surface 15 that acts in the closing direction and delimits a control chamber 17, which is contained in a valve component 16 and is connected to the injection line 2 via an inlet throttle 18. An outlet throttle 19 leads from the control chamber 17 and can be connected via a control valve 20 (valve-closure member 21) embodied, for example, in the form of a 2/2-way solenoid valve to a low-pressure-side diversion chamber 22. In order to convey leakage oil away from the region of the holding body 13, a leakage oil return line 23 in the form of an axial through bore is provided in the valve component 16, leading from a low-pressure guide bore 13 of the holding body 14 to the diversion chamber 22. The holding body 14 can be produced with a greater wall thickness so that for example, a longer and more ruggedly constructed valve-clamping screw 24 (more load-bearing thread turns) can be used to clamp the valve component 16, in turn permitting increases in pressure.

The control surfaces 11, 14 and the closing spring 7 are embodied so that when the control valve 20 is closed, i.e. when the same pressure prevails in the pressure chamber 10 and the control chamber 17, the nozzle needle 5 closes the injection ports 9. The inlet throttle 18 is smaller than the outlet throttle 19 so that when the control valve 20 opens, the pressure prevailing in the control chamber 17 is reduced via the diversion chamber 22 and the pressure prevailing in the pressure chamber 10 is then sufficient to open the nozzle needle 5 in opposition to the action of the closing spring 7.

The embodiment shown in FIG. 3 differs from the embodiment shown in FIG. 2 only in that in this instance, the leakage oil return line 23′ does not feed directly into the diversion chamber 22, but rather—with the same hydraulic function—laterally into an outer surface 25 of the valve component 16 and from there, is conveyed upward to the low-pressure side.

1-5. (canceled)

6. A fuel injector for internal combustion engines, the injector comprising a nozzle needle that is guided in an axially movable fashion in a nozzle body and opens or closes at least one injection port for a fuel injection, a valve piston that is guided in an axially movable fashion in a holding body and controls the opening and closing motion of the nozzle needle, a valve component in which the valve piston delimits a control chamber connected to a high-pressure side and also connected via a control valve to a low-pressure side, and a leakage oil return line extending at least in part inside the valve component for conveying leakage oil away from the region of the holding body.

7. The fuel injector as recited in claim 6, wherein the leakage oil return line feeds into a low-pressure-side diversion chamber of the control valve.

8. The fuel injector as recited in claim 6, wherein the leakage oil return line comprises a single through bore.

9. The fuel injector as recited in claim 7, wherein the leakage oil return line comprises a single through bore.

10. The fuel injector as recited in claim 6, wherein the leakage oil return line extends exclusively inside the valve component.

11. The fuel injector as recited in claim 7, wherein the leakage oil return line extends exclusively inside the valve component.

12. The fuel injector as recited in claim 8, wherein the leakage oil return line extends exclusively inside the valve component.

13. The fuel injector as recited in claim 9, wherein the leakage oil return line extends exclusively inside the valve component.

14. The fuel injector as recited in claim 6, wherein the leakage oil return line feeds laterally into an outer surface of the valve component and from there, leakage oil is conveyed to the low-pressure side.

15. The fuel injector as recited in claim 7, wherein the leakage oil return line feeds laterally into an outer surface of the valve component and from there, leakage oil is conveyed to the low-pressure side.
